(19) United States
(12) Patent Application Publication
(10) Pub. No.: US 2026/0264746 A1
(43) Pub. Date: Sep. 10, 2026

(54) Steering System

(71) Applicant: AGCO International GmbH, Neuhausen (CH)

(72) Inventors: Tobias Reimann, Marktoberdorf (DE); Bernd Glaser, Marktoberdorf (DE); Gabriel Reitemann, Marktoberdorf (DE)

(21) Appl. No.: 18/994,485

(22) PCT Filed: Jun. 1, 2023
(86) PCT No.: PCT/IB2023/055629

§ 371 Date: Jan. 14, 2025

(30) Foreign Application Priority Data
Jul. 19, 2022 (GB) 2210556.3

(51) Int. Cl. B62D 5/065; B62D 5/09; B62D 15/02

(52) U.S. Cl. CPC B62D 5/065; B62D 5/09; B62D 15/021

(57) ABSTRACT

A hydraulic steering system for a vehicle comprises first and second steerably mounted wheels and a hydraulic actuator connected to provide a steering force to the wheels. A steering control system receives a first control input and provides a first control output to the actuator in dependence on the first control input. A steering angle sensor detects a steering angle of the wheels and provides steering angle signal to an ECU forming part of the steering control system. The ECU provides a second control output operative to reduce the pressure of fluid provided to the steering actuator so as to reduce the steering force if the detected steering angle is greater than a first angle (α1), which is less than the maximum permitted steering angle (αmax1).

### FIELD

Embodiments of the present disclosure relate generally to a steering system for a vehicle, which may for example be a utility vehicle such as a tractor, to a vehicle having such a control system and to a method of operating such a steering system.

### BACKGROUND

Hydraulic steering systems are typically used in vehicles where high steering forces may be required, for example in agricultural vehicles or other types of utility vehicles. An exemplary hydraulic steering system is illustrated in FIG. 1. The steering system 100 comprises first and second hubs 101a, 101b for mounting respective wheels thereto. The hubs 101a, 101b are pivotably connected to opposing ends of a main body 103, which may be an axle casing, with each hub 101a, 101b being pivotable about a respective hub axis 102a, 102b. The hubs 102a, 102b are limited to pivot through maximum steering angles by mechanical stops. This is illustrated in FIG. 1 with reference to the second hub 101a, where maximum steering angles α_{max1R}, α_{max1L} are defined by adjustable stops 104a, 104b on the hub 101b relative to corresponding fixed end stops 105a, 105b on the main body 103. Stops 104a, 105a define a maximum right hand steering angle α_{max1R} and stops 104b, 105b define a maximum left hand steering angle α_{max1L}. The stops 104a, 104b, 105a, 105b engage to prevent contact between a wheel mounted on the hub 101b and other parts of the vehicle of which the steering system 100 forms a part. Corresponding stops are provided in relation to the first hub 101a to define maximum steering angles. Adjustment of the stops 104a, 104b may be made for example depending on the size of the wheels/tyres mounted to the hubs 101a, 101b.

A hydraulic pump (not shown in FIG. 1) provides a supply of hydraulic fluid to a hydraulic actuator 106 which provides steering forces to the first and second hubs 101a, 101b. The hydraulic actuator 106 is in the form of a double acting hydraulic cylinder, the cylinder divided into first and second chambers by a piston (not shown in FIG. 1) which is connected with the first and second hubs via linkages 107a, 107b, 108a, 108b and pivots 109a, 109b. Movement of the piston along the cylinder in response to a pressure differential between the first and second chambers applies a steering force to the steered wheels. The forces required to be provided by the actuator will tend to be higher for larger and heavier vehicles and when larger wheels are used. The stops 104a, 104b, 105a, 105b need to be able to withstand these forces without being damaged. A problem arises in providing a hydraulic steering system capable of providing higher steering forces without the need to modify the mechanical steering angle stops so as to be capable of withstanding the higher forces without being damaged.

### BRIEF SUMMARY

In an aspect of the invention, there is provided a hydraulic steering system comprising: first and second steerably mounted wheels; a hydraulic steering actuator connected to provide a steering force to the first and second wheels; a steering actuator control system configured to receive a first control input indicative of a steering demand and provide a first control output to the steering actuator to apply a steering force to the first and second wheels; a steering angle sensor mounted to detect a steering angle of at least one of the first and second wheels and to provide a steering angle signal indicative of the detected steering angle; the steering actuator control system comprising an electronic control unit configured to receive the steering angle signal from the angle sensor; wherein the electronic control unit is configured to monitor the steering angle signal and to provide a second control output operative to reduce the pressure of fluid provided to the steering actuator so as to reduce steering force applied by the steering actuator to the first and second wheels if the steering angle signal is indicative that the detected steering angle is greater than a first angle.

The steering system enables a high steering force to be applied to the steered wheels over the majority of their permitted steering angle range to provide a fast steering response, with the steering force being reduced as the steered wheels approach a maximum permitted steering angle at which mechanical end stops would be engaged. The reduced steering force can be selected to ensure that the mechanical end stops are not damaged.

In some embodiments, the electronic control unit is configured to provide the second control output to reduce the steering force from a first steering force up to the first angle to a second lower steering force at a second angle greater than the first angle.

In some embodiments, the steering actuator control system further comprises a hydro-mechanical steering control unit, the steering system further comprising: a hydraulic pump configured to pump a supply of hydraulic fluid from a tank to the hydro-mechanical steering control unit, the hydro-mechanical steering control unit having an inlet port connected to receive the supply of hydraulic fluid from the hydraulic pump, a return port connected to direct hydraulic fluid to the tank, and first and second working ports connected with the hydraulic steering actuator; a pressure limiting system for limiting the pressure of hydraulic fluid supplied to the actuator, the pressure limiting system including at least one hydraulic line connected between the hydro-mechanical steering control unit and the tank and at least one pressure limitation valve connected in the at least one hydraulic line between the hydro-mechanical steering control unit and the tank, the pressure limiting system configured to limit the pressure of hydraulic fluid supplied to the steering actuator to a first pressure value; wherein the electronic control unit is configured to provide the second control output to control operation of the pressure limiting system so as to limit the pressure of hydraulic fluid provided to the steering actuator to a second pressure value which is lower than the first pressure value when the detected steering angle is greater than the first angle.

In some embodiments, the at least one hydraulic line comprises a main hydraulic line connected between the hydro-mechanical steering control unit and the tank and a first pressure limitation valve in the main hydraulic line, the first pressure limitation valve configured to open above the first pressure; the pressure limiting system including a bypass line connected in parallel to the first pressure limitation valve between the hydro-mechanical steering control unit and the tank, the bypass line comprising a series connection of a second pressure limitation valve configured to open above a second pressure and a blocking valve, the second pressure being lower than the first pressure; wherein the electronic control unit is configured to provide the second control output to open the blocking valve when the detected steering angle is greater than the first angle. The second pressure of the second pressure limitation valve may be adjustable and the electronic control unit configured to provide a third control output to the second pressure limitation valve to control the second pressure.

In some embodiments, the at least one pressure limitation valve is an electronically controllably proportional pressure limitation valve, the electronic control unit configured to provide the second control output to reduce the pressure at which the pressure limitation valve opens if the angle measurement is greater than the first steering angle.

In some embodiments, the at least one hydraulic line is fluidly connected with a load sensing port of the hydro-mechanical steering control unit. The pump may be a variable displacement pump and the LS port may be connected with a pump control system for controlling the output of the pump and the at least one hydraulic line connected to a load sensing hydraulic line between the LS port and the pump control system. The system may include a pressure adjustment valve in a supply line from the pump to the inlet port P of the hydro-mechanical steering control unit, the pressure adjustment valve having a pilot port connected with the steering system load sensing line and configured to adjust the pressure of fluid supplied to the inlet port P of the hydro-mechanical steering control unit in dependence on the pressure in the steering system load sensing line. In embodiments, the pump may supply at least one further hydraulic consumer in addition to the steering system and a load sensing arrangement may comprise the steering system load sensing line connected with the LS port of the hydro-mechanical steering control unit and a further load sensing line connected with the at least one further hydraulic consumer, the two load sensing lines being connected with the pump control system through a valve arrangement configured to forward the highest pressure in the two load sensing lines to the pump control system, and the at least one hydraulic line of the pressure limiting system is connected with the steering system load sensing line.

In some embodiments, the at least one hydraulic line is fluidly connected with the inlet port of the hydro-mechanical steering control unit. The at least one hydraulic line may be fluidly connected to a hydraulic supply line from the pump to the hydro-mechanical steering control unit.

In some embodiments, the electronic control unit is configured to reduce the steering force according to a difference between the detected steering angle and the first angle when the detected steering angle is greater than the first angle.

In some embodiments, the electronic control unit is configured to reduce the steering force in proportion to the difference between the detected steering angle and the first angle when the detected steering angle is greater than the first angle.

The steering system may have adjustable end stops configured to limit the steering angle of the first and second wheels to a maximum steering angle that is greater than the first angle.

In a further aspect of the invention, there is provided a hydraulic steering system for a vehicle comprising a hydraulic steering actuator connected to provide a steering force to at least one steered wheel of a vehicle; a steering actuator control system configured to receive a first control input and provide a first control output to the steering actuator; a steering angle sensor mounted to detect a steering angle of the at least one steered wheel and to provide a steering angle signal indicative of the detected steering angle; the steering actuator control system comprising an electronic control unit configured to receive the steering angle signal from the angle sensor and a hydro-mechanical steering control unit; the steering system further comprising a hydraulic pump configured to pump a supply of hydraulic fluid from a tank to the hydro-mechanical steering control unit and a pressure limiting system for limiting the pressure of hydraulic fluid supplied to the actuator from the pump, wherein the pump is a variable displacement pump and the pressure limiting system includes at least one hydraulic line connected between a load sensing port LS of the hydro-mechanical steering control unit and the tank and at least one pressure limitation valve connected in the at least one hydraulic line, the pressure limiting system configured to limit the pressure of hydraulic fluid supplied to the steering actuator to a first pressure value; wherein the electronic control unit is configured to monitor the steering angle signal and to provide a second control output to control operation of the pressure limiting system so as to limit the pressure of hydraulic fluid provided to the steering actuator to a second pressure value which is lower than the first pressure value if the steering angle signal is indicative that the detected steering angle is greater than a first angle.

The pump may be a variable displacement pump and the LS port may be connected with a pump control system for controlling the output of the pump and the at least one hydraulic line connected to a load sensing hydraulic line between the LS port and the pump control system. The system may include a pressure adjustment valve in a supply line from the pump to the inlet port P of the hydro-mechanical steering control unit, the pressure adjustment valve having a pilot port connected with the steering system load sensing line and configured to adjust the pressure of fluid supplied to the inlet port P of the hydro-mechanical steering control unit in dependence on the pressure in the steering system load sensing line. In embodiments, the pump may supply at least one further hydraulic consumer in addition to the steering system and a load sensing arrangement may comprise the steering system load sensing line connected with the LS port of the hydro-mechanical steering control unit and a further load sensing line connected with the at least one further hydraulic consumer, the two load sensing lines being connected with the pump control system through a valve arrangement configured to forward the highest pressure in the two load sensing lines to the pump control system, and the at least one hydraulic line of the pressure limiting system is connected with the steering system load sensing line.

In some embodiments, the at least one hydraulic line comprises a main hydraulic line connected between LS port of the hydro-mechanical steering control unit and the tank and a first pressure limitation valve in the main hydraulic line, the first pressure limitation valve configured to open above the first pressure; the pressure limiting system including a bypass line connected in parallel to the first pressure limitation valve between the LS port of the hydro-mechanical steering control unit and the tank, the bypass line comprising a series connection of a second pressure limitation valve configured to open above a second pressure and a blocking valve, the second pressure being lower than the first pressure; wherein the electronic control unit is configured to provide the second control output to open the blocking valve when the detected steering angle is greater than the first angle. The second pressure of the second pressure limitation valve may be adjustable and the electronic control unit configured to provide a third control output to the second pressure limitation valve to control the second pressure.

The electronic control unit may be a computer and/or may comprise a programmable processor.

In some embodiments, the at least one pressure limitation valve is an electronically controllably proportional pressure limitation valve, the electronic control unit configured to provide the second control output to reduce the pressure at which the pressure limitation valve opens if the angle measurement is greater than the first steering angle.

In a further aspect of the invention, there is provided a vehicle comprising a steering system according to either of the previous aspects of the invention. The vehicle may be a utility vehicle such as a tractor.

In a still further aspect of the invention, there is provided a method of operating a hydraulic steering system comprising: first and second steerably mounted wheels; a hydraulic steering actuator connected to provide a steering force to the first and second wheels, a steering actuator control system configured to receive a first control input indicative of a steering demand and provide a first control output to the steering actuator to apply a steering force to the first and second steerably mounted wheels, a steering angle sensor mounted to detect a steering angle of at least one of the first and second wheels and to provide a steering angle signal indicative of the detected steering angle, and an electronic control unit configured to receive the steering angle signal from the steering angle sensor and to provide a second control output operative to reduce the pressure of fluid to the hydraulic steering actuator so as to reduce steering force;
the method comprising: the electronic control unit monitoring the steering angle signal and providing the second control output operative to reduce the pressure of fluid to the hydraulic steering actuator and so reduce the steering force applied by the steering actuator to the first and second wheels if the steering angle signal is indicative that the detected steering angle is greater than a first angle.

In some embodiments, the method comprises reducing the steering force according to a difference between the detected steering angle and the first angle when the detected steering angle is greater than the first angle. The method may comprise reducing the steering force in proportion to the difference between the detected steering angle and the first angle when the detected steering angle is greater than the first angle.

Still other embodiments involve a computer-readable storage medium (e.g., a non-transitory computer-readable storage medium) having processor-executable instructions configured to implement one or more of the techniques presented herein.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the disclosure will now be described, by way of example only, with reference to the accompanying drawings, in which:

FIG. 1 is a plan view from above of an example steering system for a vehicle;

FIG. 2 is a schematic diagram of an example hydraulic steering system;

FIGS. 3A and 3B are schematic plan views of example steering systems with wheels positioned at a maximum steering angle;

FIGS. 4A and 4B are schematic plots of hydraulic pressure as a function of steering angle for the example steering systems of FIGS. 3A and 3B;

FIG. 4C is a schematic plot of hydraulic pressure as a function of steering angle for an alternative example steering system illustrated in FIG. 5;

FIG. 5 is a schematic diagram of an alternative example hydraulic steering system;

FIG. 6 is a schematic diagram of an alternative example hydraulic steering system;

FIG. 7 is a schematic diagram of an alternative example hydraulic steering system;

FIG. 8 is a schematic flow diagram of an example method of operating a steering system; and,

FIG. 9 is a somewhat schematic side view of a vehicle in the form of an agricultural tractor having a steering system according to the disclosure.

### DETAILED DESCRIPTION

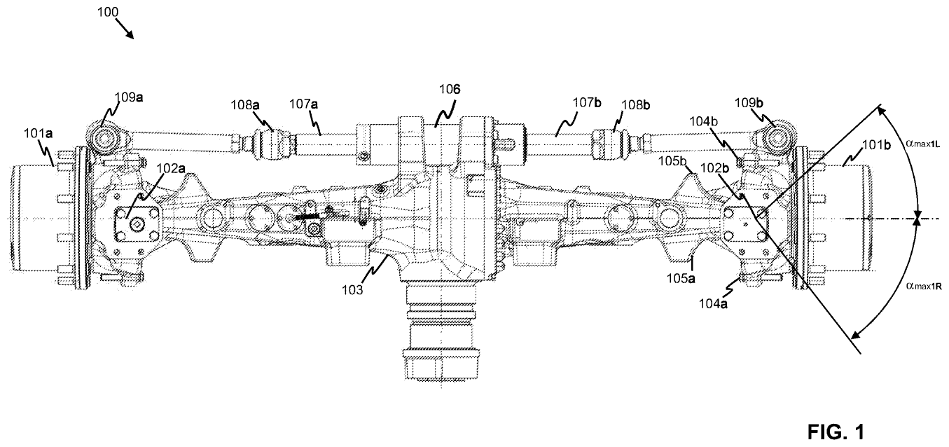

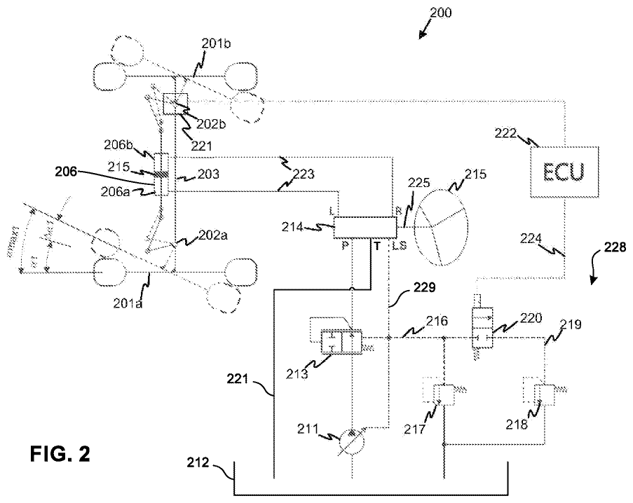

FIG. 2 illustrates an example hydraulic steering system 200. The system 200 drives first (or left) and second (or right) wheels 201a, 201b via a hydraulic actuator 206 in a manner similar to the system 100 illustrated in FIG. 1. This enables the wheels 201a, 201b to be pivoted about respective hub axes 202a, 202b relative to a main body or axle 203 to which the wheels 201a, 201b are steerable mounted by means of hubs similar to those shown in FIG. 1. End stops, which may also be similar to those illustrated in FIG. 1, are provided to limit the maximum steering angle of the steered wheels 201a, 201b. The end stops may be adjustable. With reference to the first wheel 201a, a maximum right hand steering angle αₘₐₓ₁ is shown as having been set. A maximum left hand steering angle is also set by corresponding stops.

In the example shown in FIG. 2, the steering actuator 206 is a double acting hydraulic cylinder in which a piston 215 divides the cylinder 206 into two chambers 206a, 206b. The piston 215 is moveable within the cylinder and is mechanically coupled to hubs on which the steered wheels are mounted such that a pressure difference between the chambers 206a, 206b will cause the piston to move within the cylinder and the wheels 201a, 201b to turn together about the hub axes 202a, 202b to provide a conjoint steering movement. In other examples, the actuator may include two double acting hydraulic cylinders, one for each for each wheel 201a, 201b or side of the vehicle.

The steering system 200 is capable of providing hydraulic pressures in the steering actuator 206 that produce steering forces to the wheels 201a, 201b that may result in forces on the stops that exceed their design limits. To prevent damage occurring as a result, a first steering angle o1 is set that is less than the maximum steering angle αₘₐₓ₁ by a difference Δα₁. When a steering input is requested that results in the steering angle exceeding the first steering angle α₁, the pressure of hydraulic fluid provide to the steering actuator 206 is reduced so that, when the steering angle reaches the maximum steering angle αₘₐₓ₁, the force applied to the end stops does not exceed their design limit, thereby avoiding the possibility of damage.

The hydraulic steering system 200 comprises a hydraulic pump 211, which pumps hydraulic fluid from a tank 212 through a pressure adjustment valve 213 to an inlet port P of a hydro-mechanical steering control unit 214. In addition, the steering control unit 214 has a tank port T connected to the tank 212 via a return line 227. The return line 227 serves to return hydraulic fluid when steering control unit 214 is not actuated or the pump delivers more oil flow than required for steering. The return line 227 also serves to return hydraulic fluid to the tank from the steering actuator 206 when the steering control unit 214 is actuated to cause the steering actuator 206 to move. The steering control unit 214 may for example be an Orbitrol(R) hydrostatic valve, available from Danfoss Power Solutions APS. A first control input 225, which is provided to the steering control unit 214, is provided by a steering wheel 215. The first control input 225 may be provided mechanically via a steering column or shaft to which the steering wheel is mounted and which is coupled to the hydro-mechanical steering unit 214. Alternatively, the first control input 225 may be provided in other ways such as from a joystick control or by computer control which may regulate actuation of a motor to turn an input shaft of the hydro-mechanical steering unit. The steering control unit 214 comprises first (or left) and second (or right) working ports L, R, each connected to a respective one of the chambers 206a, 206b of the hydraulic cylinder 206. The hydro-mechanical steering control unit 214 provides a first control output 223 in the form of a differential pressure between the first and second working ports L, R that provides the steering force to the first and second wheels 201a, 201b.

The pump 211 in this embodiment is a variable displacement pump and a load sensing port LS of the steering control unit 214 is connected to an output control system of the pump 211 by means of a load sensing hydraulic line 229 (hereinafter the LS line) to control the hydraulic pressure provided by the pump 211 in a known manner. A pressure limiting system 228 for limiting the pressure supplied to the steering control unit 214 and hence to the actuator 206 includes a main hydraulic line 216 connecting the LS line 229 to the tank via a first pressure limitation valve 217. The first pressure limitation valve 217 is configured to open when a pressure in the further hydraulic line 216 exceeds a first pressure p1. The first pressure limitation valve 217 acts as a safety device to prevent hydraulic pressure supplied to steering control unit 214 and the steering actuator 206 exceeding a safe level during normal operation. The first pressure p1 may, for example, be around 195 bar. The pressure limiting system 228 may include a second pressure limitation valve 218 provided in a bypass line 219 connected in parallel with the first pressure limitation valve 217 between the LS line 229 and the tank 212, the second pressure limitation valve 218 connected in series with an electronically controllable blocking valve 220. The second pressure limitation valve 218 is configured to open when a pressure in the bypass line 219 exceeds a second pressure p2. The second pressure p2 is less than the first pressure p1 and may for example be around 145 bar. In a general aspect, the second pressure p2 may be between around 50% and 90% of the first pressure, or between around 60% and 90%, between around 70% and 80%, or in a specific example around 75% of the first pressure p1.

An angle sensor 221 is mounted to detect a steering angle of the wheels 201a, 201b. A single angle sensor 221 operative to detect a steering angle of one of the wheels 201a, 201b may be sufficient, since the wheels 201a, 201b will steer together under normal circumstances. An electronic control unit (ECU) 222 receives a steering angle signal (angle measurement) indicative of the detected steering angle from the angle sensor 221 and provides a second control output to the blocking valve 220 dependent on the steering angle signal. The ECU 222 is configured to provide the second control output to open the blocking valve 220 if the detected steering angle is greater than the first steering angle α1. The effect of this is to limit the hydraulic pressure in the steering circuit between the hydro-mechanical steering control unit 214 and the steering actuator 206 to the second pressure p2, which reduces the force available to turn the wheels 201a, 201b. If the steering input 225 is increased further towards the maximum steering angle αₘₐₓ₁, the force applied to the steering end stops will be limited by the reduced pressure p2 set by the second pressure limiting valve 218, thereby preventing damage to the end stops and/or any other connected components.

The ECU 222 may be dedicated to the steering system or it may be part of a general control system for the vehicle. The ECU 222 and the hydro-mechanical steering control unit 214 can be regarded as part of a control system for the steering actuator 206.

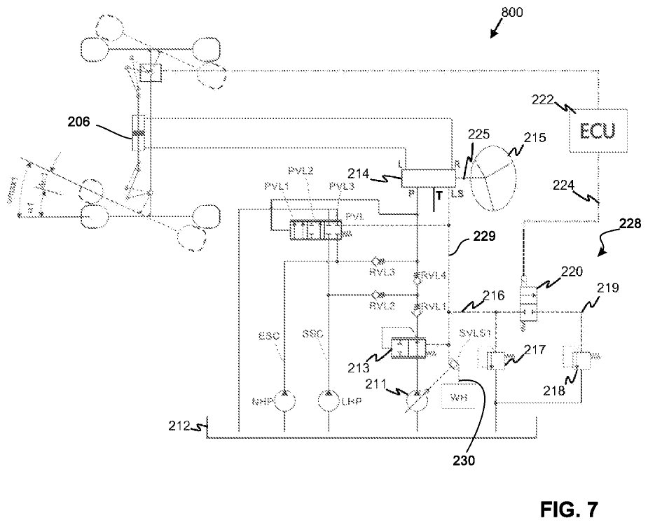

In the hydraulic steering system 200 illustrated in FIG. 2, the pressure adjustment valve 213 is located in the supply line from the pump 211 to the pressure port P of the steering control unit 214. A pilot port of the pressure control valve 213 is connected to the steering system load sensing line 229 and the arrangement is configured such that the valve 213 limits the pressure of fluid supplied to the steering system in dependence on the pressure of the load sensing signal from the LS port of the steering control unit 214. The valve 213 is also biased to the open position by a spring to maintain a minimum working pressure differential in the steering system for effective operation of the valves. The minimum working pressure differential may typically be in the region of 5 to 10 bar but other values are possible. As a result, the pressure of the fluid supplied to the steering control unit 214 and steering actuator 206 will be higher than the pressure in the load sensing line 229 by the minimum working pressure differential. Thus the pressure limiting valves 217, 218 should be set to open at pressures which are lower than the target pressures to the steering actuator 206 by the minimum working pressure differential. For example, in the above example, if the minimum working pressure differential is 5bar and the first pressure limiting valve is set to open at 195 bar, the maximum permitted pressure in the steering system is 200 bar. Similarly, setting the second pressure limiting valve 218 to open at 145 bar, will result in a reduced pressure supplied to the steering actuator of 150 bar when the detected steering angle exceeds the first angle α1. It will be appreciated that these pressure values are exemplary only and are not intended to be limiting. The pressure adjustment valve 213 is particularly useful where the pump 211 supplies at least one other hydraulic consumer in addition to the steering system and where the load sensing system includes an input from the other hydraulic consumer. In the event the hydraulic demand from the other consumer is higher than that of the steering system, the pump output would be increased to meet this hydraulic demand. However, the pressure adjustment valve 213 ensures that the hydraulic pressure supplied to the pressure port P of the steering control unit 214 is regulated in dependence on the hydraulic demand of the steering system. In the event that the pump 211 only supplies the steering system, the pressure adjustment valve 213 could be omitted. Operation of the pressure adjustment valve 213 is described further below with reference to the hydraulic supply system illustrated in FIG. 7.

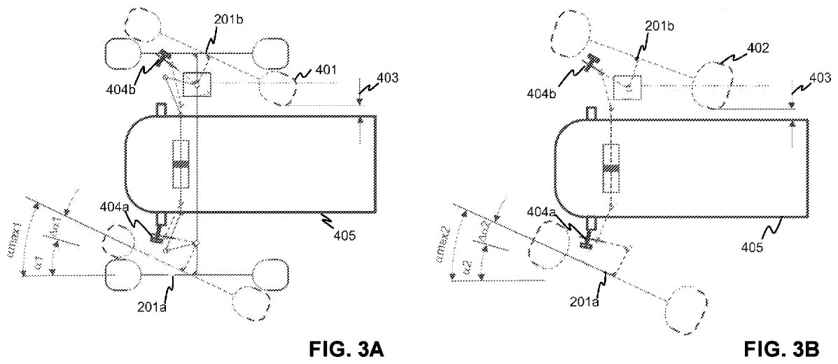

Tractors may be operated with different tyre configurations. For example, tyres with greater diameter and width may be required for heavy field work, smaller tyres for crop care (spraying) or further tyres for transportation on road. FIG. 3A and FIG. 3B illustrate schematically the effect of adjustable end stops 404a, 404b in defining the maximum steering angle αmax1, αmax2 when different tyre configurations are used on a vehicle. In a first example in FIG. 3A, the end stops 404a, 404b are set so that a minimum distance 403 is set between a tyre 401 of the wheels 201a, 201b and the vehicle body 405 (e.g., the bonnet or the frame) when end stops 404a, 404b for a right hand turn are engaged, resulting in a first maximum steering angle αmax1. In a second example in FIG. 3B, the wheels 201a, 201b are fitted with different, larger tyres 402. The end stops 404a, 404b in this case are set so that the same minimum distance 403 is set between the tyre 402 and the vehicle body 405 when the end stops are engaged in a right hand turn. This sets a smaller, second maximum steering angle αmax2 and a smaller first angle α2 is selected appropriate to the second maximum steering angle αmax2. The first angle α1, α2 above which the steering force is reduced will usually be different when different sized tyres are used on a vehicle requiring the end stops 404a, 404b to be adjusted. They will though be below the minimum value of the maximum steering angle capable of being set by the adjustable end stops 404a, 404b. Other components in FIGS. 3A, 3B may be similar to those illustrated in FIG. 2 and described above.

There may be set values for first steering angle value α1 assigned to specific tyre configurations supplied by the manufacturer which can be adopted. However, manufacturing tolerances may require a calibration method be used to set an appropriate value for the first steering angle α1. Calibration may also be required if tyre configurations are adopted which are not covered in a predetermined range of set values. This might be the case for example if tyre configurations not supplied by the vehicle manufacturer are used. An initial calibration would typically be carried out by the vehicle manufacturer. However, the system may be required to be recalibrated if the tyre configuration used on a vehicle is changed or to allow for general wear and tear.

A suitable calibration method will now be described, initially with reference to a first calibration carried out by a vehicle manufacturer.

Once the end stops 404a, 404b have been adjusted, the ECU 222 is brought into a calibration mode. In the calibration mode, the hydraulic fluid pressure supplied to the steering control unit 214 and steering actuator 206 may be limited to the reduced second pressure p2 to avoid damage to the stops. However, this need not be the case. A message may be displayed to the user via a screen or other HMI to advise that a calibration mode has been entered and there may be an option to abort the calibration. Where the steering system is subject to a reduced pressure during calibration, the message may advise that only reduced steering capability is available. The user is then asked to move the steering system to maximum steering angle in a first direction so that end stops 404a or 404b are engaged while force to turn the steering wheel continues to be applied. Engagement of the end stops may be determined by means of an angle sensor associated with the steering wheel and the steered wheel angle sensor 221. When the steered wheel angle sensor 221 indicates that the steered wheels have stopped turning despite the steering wheel being turned further, this is indicative that the steering wheel stops have been engaged. However, other arrangements for determining that the end stops are engaged or an input provided by a user to confirm that the end stops are engaged can be used. Once the ECU has determined or been told that the end stops 404a, 404b are engaged, the ECU determines maximum steering angle αmax1 based on an input from the steered wheel angle sensor 221. The ECU then calculates an appropriate value for first steering angle α1 based on the determined maximum steering angle αmax1. The first steering angle α1 may be a percentage of the maximum steering angle αmax1 or it may be calculated by deducting a set angular distance from the maximum steering angle αmax1, for example. The system is then calibrated for the tyre configuration.

Generally it is expected that the maximum steering angle αmax1 will be the same for turns in either direction, e.g., right and left. However, manufacturing tolerances or design issues may result in different maximum steering angles αmax1 for right and left hand turns. In this case, the first angle α1 may be set differently for right and left turns. To cater for this, the calibration method may require that after calibrating the system for a turn in the first direction, the procedure is repeated to calibrate the system for turns in the other direction.

A similar calibration method can be adopted as part of a vehicle after sales service, undertaken by a user (e.g., a farmer or other end user) following a change in the tyre configuration, and/or periodically to ensure the system remains effective despite wear and tear. The user enters the ECU 222 in the calibration mode and follows the instructions provided by a visual display to carry out the calibration method as discussed above.

The system may also be configured to carry out a check to determine if recalibration is required. As part of the check, when the steering end stops 404a, 404b are engaged, the maximum steering angle αmax1 is determined by the ECU. If there is a significant deviation in the maximum steering angle αmax1 previously saved in the system (say during the last calibration), this indicates that the tyres may have been changed and the steering end stops adjusted such that a calibration of the steering control system is required. The control system may issue a warning that the maximum steering angle αmax1 has changed and that calibration may be necessary. The check may be conducted whenever the vehicle is being operated each time the steering end stops 404a, 404b are engaged or only on a periodic basis.

The above calibration method is preferably carried out with the vehicle on a smooth, hard surface, such as a road or the like, rather than in an agricultural field. In a field, obstacles, such as stones or furrows, may prevent the steered wheels turning far enough to engage the steering stops.

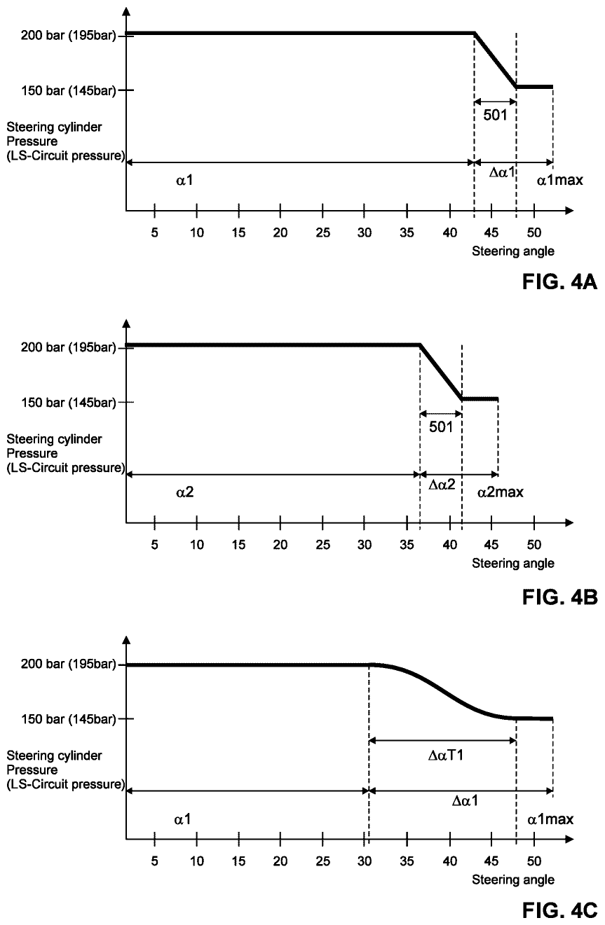

FIGS. 4A and 4B illustrate example hydraulic pressures as a function of steering angle for the examples of FIGS. 3A and 3B respectively. In each case the first steering angle α1, α2, beyond which the steering cylinder pressure is reduced, is at least say 35 degrees. The maximum steering angle αmax1 in FIG. 4A is around 53 degrees and the first steering angle α1 is about 43 degrees. In the example of FIG. 4B, the maximum angle αmax2 is around 46 degrees and the first steering angle α2 is about 36 degrees. In these examples, the first steering angle α1, α2 is about 10 degrees before the respective maximum steering angle αmax1, αmax2. In each case, the pressure in the steering actuator 206 is limited to a first higher level p1 up to the first angle α1, α2 and is reduced to a second lower level p2 beyond the first angle α1, α2. The pressures p1, p2 in these particular non-limiting examples are 200 bar (195 bar in the pressure sensing circuit) and 150 bar (145 bar in the pressure sensing circuit) but can be set as necessary for any given steering system.

In a range 501 beyond the first angle α1, α2, the pressure reduces from the first higher level p1 to the second lower level p2, providing a gradual transition in steering force when the steering angle exceeds the first angle α1, α2. This results in a smoother transition when steering at higher angles, avoiding an abrupt change in steering behaviour. The transition may be linear as illustrated in FIGS. 4A, 4B or may be a more gradual transition without sharp changes in pressure. In alternative examples, the pressure may be a step change from the first pressure p1 to the second pressure p2 at the first angle α1, α2.

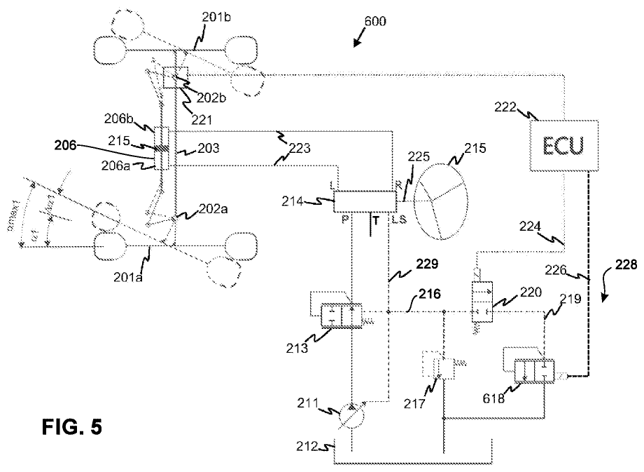

FIG. 5 illustrates an alternative hydraulic steering system 600 in which the second pressure limitation valve 618 is a proportional valve adjustable by the electronic control unit 222 to provide a controlled change in fluid pressure from the first pressure level p1 to the second pressure level p2 over a prolonged transition period ΔαT1 as illustrated in FIG. 4C. FIG. 4C illustrates hydraulic pressures as a function of steering angle for the example of FIG. 3A using the system of FIG. 5. A comparison between FIGS. 4A and 4C shows that using the embodiment of FIG. 5, the transition from the first higher pressure p1 can start at a smaller first steering angle α1, in this case just over 30 degrees, and end at a steering angle which is closer to the maximum steering angle αmax1, in this case about 47 degrees. The use of an electronically controllable a proportional second pressure limitation valve 618 provides a more gradual transition in steering force which can be shaped/profiled to provide appropriate steering characteristics.

Where the second pressure limitation valve is an electronically controllable proportional valve 618, the calibration method described above would be modified so that the ECU 222 calculates both a suitable first steering angle α1 and transition period ΔαT1 once the maximum steering angle αmax1 has been determined. The profile of the change in hydraulic pressure may also be varied.

In a general aspect therefore, the ECU is operative to reduce the maximum permitted steering force from a first level when the steering angle is less than or equal to the first angle α1 to a second lower force level when the steering angle is in excess of the first angle α1. The steering force may be: i) reduced in a step function; ii) reduced in proportion to a difference between the angle measurement and the first angle when the angle measurement is greater than the first angle; or iii) reduced from the first force to the second force according to a sigmoid function when the angle measurement is greater than the first angle. The advantage of a proportional reduction or a sigmoid function reduction is that of avoiding an abrupt change in steering behaviour of the vehicle.

In the present disclosure, including the claims, it is assumed that the steering angle is expressed in positive terms regardless of the direction of turn. In some systems, the steering angle may be expressed positively for a turn in one direction, say to the right, and in negative terms for a turn in the opposite direction, say a turn to the left. Regardless of the manner in which the steering angle is expressed, it will be understood that in accordance with the present disclosure the steering force is reduced as the steered wheels approach a maximum permitted steering angle in either direction prior to the steering end stops 404a, 404b engaging. Where a system expresses the steering angle in negative terms for a turn in one direction, the first angle α1 for turns in that direction can be defined as a negative angle. In this case, it should be understood that references herein (including in the claims) to the detected steering angle being “above”, “greater than”, “beyond”, or “exceeding” (and other similar expressions) a first angle are intended to encompass a situation in which the detected steering angle has a larger negative value than a negatively expressed first angle. For example, if the first angle α1 is set at −35 degrees for a left turn, a determined steering angle of −36 degrees to the left would be regarded as being “above”, “greater than”, “beyond”, or “exceeding” the first angle and the reduced steering force applied.

In an alternative arrangement to that shown in FIG. 5, the blocking valve 220 and first pressure limitation valve 217 may be omitted and a single adjustable pressure limitation valve 618 provided in a hydraulic line between the steering control unit 214 and the tank 212. In this case, the ECU 222 is configured to control the opening pressure of the pressure limitation valve 618 according to the detected steering angle. The opening pressure may be varied for example according to the relationships described above regarding FIG. 4C. An advantage of this arrangement is that a reduced number of components is required. However, in this embodiment the pressure limitation valve 618 will be operative over the entire steering angle range and so must be suitable to meet safety requirements for use on the road. Whereas, in the embodiment as illustrated in FIG. 5, the second pressure limitation valve 618 would only be operative when the steering angle approaches the maximum steering angle αmax1. This would usually only happen when the vehicle is being driven slowly in off-road conditions and so the second pressure limitation valve 618 need not necessarily be road use compliant.

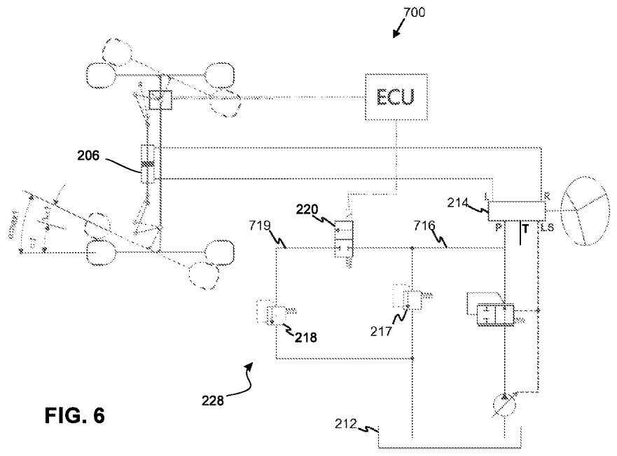

FIG. 6 illustrates an alternative example hydraulic steering system 700 to that of FIG. 2, in which the main line 716 of the pressure control system 228 is connected with the supply line from the pump to the inlet port P of the steering control unit 214 rather than to the load sensing system. Other components of the system 700 are similar to those of the system 200 described above in relation to FIG. 2, including the bypass line 719 connected in parallel to the first pressure limitation valve 217 between the steering control unit 214 and the tank 212, the bypass line comprising a series connection of the second pressure limitation valve 218 and blocking valve 220. Operation of the system 700 is similar to that of the system 200 described above. The second pressure limitation valve 218 could be replaced by an electronically controllable proportional valve 618 of the type described above in relation to FIG. 5, in which case the blocking valve 220 could be omitted. In the arrangement as shown in FIG. 6, the pressure limiting valve or valves 217, 218 are set to open at the actual desired fluid pressures to be provided to the steering actuator 206.

FIG. 7 illustrates how a hydraulic steering system as described above in relation to FIGS. 2 and 5 can be incorporated into a multi-pump hydraulic system such as are commonly found on tractors. In this example, the hydraulic steering system 800 comprises additional hydraulic pumps LHP, NHP and a prioritization valve PVL. The additional features of the system 800 are similar to those as described in EP2667039A2 in the name of AGCO International GmbH, published 27 Nov. 2013. The main supply pump 211 operates to generate a fluid pressure in the hydraulic circuit through the steering control unit 214 in normal operation. The LHP pump is a steering pump with constant displacement driven by the engine or other prime mover and can be used to supplement the supply of pressurised fluid to the steering system from the main pump 211 in circumstances where the main pump 211 is unable to maintain an adequate supply. The NHP pump is a ground speed pump driven by the wheels or other ground engaging members of the vehicle which provides an emergency steering function should the engine or other prime mover or the other pumps fail whist the vehicle is moving.

The prioritisation valve PVL has three operative positions:
a. PVL1—operative when the main supply pump 211 is operationally capable of sufficient supply. In this position, the outputs from both the steering pump LHP and the emergency steering pump NLP are connected to the fluid tank 212, so pumps LHP, NLP do not supply the steering system.
b. PVL2—operative when the main supply pump 211 is functioning but is not capable of providing a sufficient supply such that the pressure in the load sensing circuit is higher than the pressure in the supply line to the inlet port P. With the PVL in this position, the steering pump LHP then supplies hydraulic fluid to the steering control unit 214 to supplement the main pump 211. The emergency steering pump NLP is still connected to the fluid tank 212;
c. PVL3—operative when the combined contributions of the main supply pump 211 and steering pump LHP is not capable to maintain sufficient pressure (say in the event of a failure of the engine or other prime mover). In this position, connection of the steering pump LHP and emergency steering pump NLP to the fluid tank is blocked and the emergency steering pump NLP supplies the steering circuit.

In the hydraulic supply system illustrated in FIG. 7, the main pump 211 supplies other hydraulic consumers in addition to the steering system. These are referred to generically as working hydraulics (indicated schematically at WH) and could include hydraulic actuators on linkage systems at the rear and/or front of a tractor and/or on an agricultural implement attached to the tractor. The load sensing system includes a steering system branch including the steering system load sensing line 229 connected with the load sensing port LS of the steering control unit 214 and a working hydraulics branch having a working hydraulics load sensing line 230 connected with one or more load sensing ports on valves controlling operation of the working hydraulics actuators. The load sensing lines 229, 230 of the two branches are connected to a control system for adjusting the output of the main pump 211 through a shuttle valve SVLS1 so that the highest load sensing signal from the steering system or form the working hydraulics is forwarded to the main pump control system and the output of the pump adjusted accordingly. A pressure adjustment valve 213, as described above in relation to FIG. 2, is located in the supply line from the main pump to the pressure port P of the steering control unit 214 and has a port connected to the steering system load sensing line 229 of the steering system load sensing branch. The pressure adjustment valve 213 is operative to ensure that the pressure of fluid supplied to the steering control unit 214 is dependent on the load sensing signal from the steering system, even if the working hydraulics load sensing demand calls for a higher output pressure from the main pump 211 than is required by the steering system. A similar arrangement can be adopted in the hydraulic systems illustrated in FIGS. 2, 5, and 6 if the pump 211 is also used to supply a further hydraulic consumer, such as the working hydraulics, in addition to the steering system. As with the other examples described above with respect to FIGS. 2 and 5, the system comprises a pressure limiting system 228 having a main hydraulic line 216 connected to the load sensing port LS of the steering control unit 214, in this case via the steering system load sensing line 229. The pressure limiting system includes a first pressure limitation valve 217 in a main hydraulic line 216 between the steering system load sensing line 229 and the tank, and a bypass line 219 connected in parallel to the first pressure limitation valve 217 between steering system load sensing line 229 and the tank 212. The bypass line comprises a series connection of the second pressure limitation valve 218 and blocking valve 220. Operation of the system is similar to that of the examples described above. When either pressure limitation valve 217, 218 opens, this limits the pressure in the steering system line 229 of the load sensing system and so limits the pressure of fluid which is forwarded to the steering control unit 214 through the valve 213 and/or supplied by the main pump 211. The second pressure limitation valve 218 could be replaced by an electronically controllable proportional valve 618 of the type described above in relation to FIG. 5, in which case the blocking valve 220 could be omitted. In systems where the steering system is supplied by a dedicated variable displacement pump which does not supply any other hydraulic consumers of the vehicle, the pressure control valve 213 could be omitted since the steering system load sensing circuit will regulate the output of the pump and so the pressure of fluid supplied to the steering system can be controlled by the pressure limiting valves in the load sensing circuit without the need for the valve 213.

Whilst the embodiment of FIG. 6 works well, it is an advantage of connecting the hydraulic line 216 and pressure limiting valves 217, 218, 618 to the pressure sensing port LS that smaller valves can be used due to the lower flows through the pressure sensing port LS. In the embodiment of FIG. 6 where the hydraulic line 216 is connected to the inlet port P, the pressure limitation valves 217, 218 may need to be larger to handle the higher flow rates. A further advantage of using the load sensing circuit to limit the pressure supplied to the actuator 206 is that backup pumps can be connected to the inlet port P, as described above in relation to the example in FIG. 7.

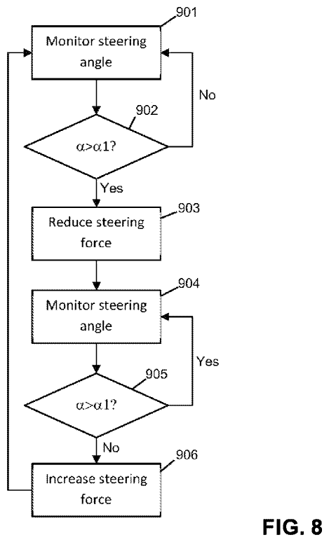

FIG. 8 is a schematic flow chart illustrating an example method of operation of any of the steering systems as described above. During normal operation of the vehicle, in a first step 901 the steering angle is continuously monitored by the ECU 222 and the monitored steering angle a compared to the first angle α1. While a is less than or equal to α1 (step 902), the ECU continues monitoring the steering angle. If a increases beyond α1 (step 902), the ECU sends a control signal to reduce the steering force (step 903), for example by opening the blocking valve 220 in the case of a hydraulic steering system according to FIGS. 2, 5, 6 and 7. The ECU then continues to monitor the steering angle (step 904), and may adjust the steering force according to the difference between the angle and the first angle to provide a gradual reduction in steering force above the first angle, for example as illustrated in FIG. 5C described above. While a remains above α1 (step 905), the ECU continues to monitor the steering angle and control the steering force accordingly. If a falls below α1 (step 905), the ECU increases the steering force back to the previous level (step 906) and continues monitoring the steering angle (step 901).

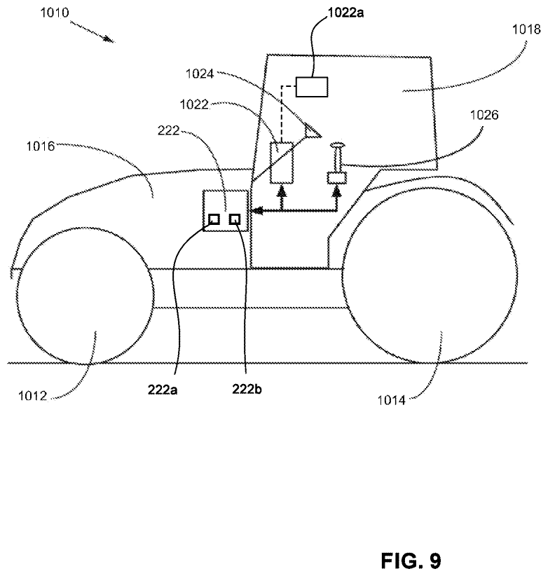

FIG. 9 illustrates an example agricultural vehicle, for example a tractor 1010, which comprises a steering system as described herein. The tractor 1010 comprises front wheels 1012 attached to the steering system, rear wheels 1014, an engine section 1016 and a cab section 1018. The tractor 1010 comprises an ECU 222, which is arranged to control operation of the various tractor systems including the steering system. The cab section 1018 is provided with operator controls 1022 for operation of the different components of the tractor 1010, including hydraulics, electrical systems and others. A steering input device is provided to control steering of the tractor 1010, for example in the form of a steering wheel 1024 and optionally a joystick controller 1026, either or both of which may be used to steer the tractor 1010. The tractor 1010 may also be steered using inputs received from the operator controls 1022. For example, the tractor 1010 may be controlled using commands input into the controls 1022, or by modules or software programs operating on an electronic device, which may be provided as part of the operator controls 1022. It will be understood that the ECU 222 is provided in communication with the operator controls 1022, and with the steering wheel 1024 and joystick controller 1026. The operator controls may include a display screen 1022a which displays information to the operator and which may be touch screen to enable an operator to input commands.

In one embodiment, the ECU or controller 222 comprises one or more processors, such as processor 222a, input/output (I/O) interface(s), and memory 222b, all coupled to one or more data busses. The memory 222b may include any one or a combination of volatile memory elements (e.g., random-access memory RAM, such as DRAM, and SRAM, etc.) and non-volatile memory elements (e.g., ROM, hard drive, tape, CDROM, etc.). The memory 222b may store a native operating system, one or more native applications, emulation systems, or emulated applications for any of a variety of operating systems and/or emulated hardware platforms, emulated operating systems, etc. In one embodiment the memory comprises an operating system and steering system control software. It should be appreciated by one having ordinary skill in the art that in some embodiments, additional or fewer software modules (e.g., combined functionality) may be stored in the memory 90b or additional memory. In some embodiments, a separate storage device may be coupled to the data bus, such as a persistent memory (e.g., optical, magnetic, and/or semiconductor memory and associated drives).

Each of the steering system sensors 221 provides an input signal to the controller 222.

Electronic communications among the various electronic components of the steering control system may be achieved over a controller area network (CAN) bus or via a communications medium using other standard or proprietary communication protocols (e.g., RS 232, etc.). Communication may be achieved over a wired medium, wireless medium, or a combination of wired and wireless media.

The processor 222a may be embodied as a custom-made or commercially available processor, a central processing unit (CPU) or an auxiliary processor among several processors, a semiconductor based microprocessor (in the form of a microchip), a macro processor, one or more application specific integrated circuits (ASICs), a plurality of suitably configured digital logic gates, and/or other well-known electrical configurations comprising discrete elements both individually and in various combinations to coordinate the overall operation of the controller 222.

While the agricultural tractor 1010 is shown as being a wheeled tractor, it will be understood that the invention may also be used on tracked tractors or agricultural harvesters. It will be understood that the invention is preferably intended for use with agricultural vehicles having power outputs of greater than 100 hp.

All references cited herein are incorporated herein in their entireties. If there is a conflict between definitions herein and in an incorporated reference, the definition herein shall control.

1. A hydraulic steering system comprising:
first and second steerably mounted wheels;
a hydraulic steering actuator connected to provide a steering force to the first and second wheels;
a steering actuator control system configured to receive a first control input and provide a first control output to the steering actuator;
a steering angle sensor mounted to detect a steering angle of at least one of the first and second wheels and to provide a steering angle signal indicative of the detected steering angle;
the steering actuator control system comprising an electronic control unit configured to receive the steering angle signal from the angle sensor;
wherein the electronic control unit is configured to monitor the steering angle signal and to provide a second control output operative to reduce the pressure of fluid provided to the hydraulic steering actuator and so reduce the steering force applied by the steering actuator to the first and second wheels if the steering angle signal is indicative that the detected steering angle is greater than a first angle (α1).

2. The steering system of claim 1, wherein the electronic control unit is configured to provide the second control output to reduce the steering force from a first steering force up to the first angle (α1) to a second lower steering force at a second angle (amax1) greater than the first angle (α1).

3. A steering system as claimed in claim 1, claim 2, wherein the steering actuator control system further comprises a hydro-mechanical steering control unit, the steering system further comprising:
a hydraulic pump configured to pump a supply of hydraulic fluid from a tank to the hydro-mechanical steering control unit, the hydro-mechanical steering control unit having an inlet port (P) connected to receive the supply of hydraulic fluid from the hydraulic pump, a return port connected to direct hydraulic fluid to the tank, and first and second working ports (L, R) connected with the hydraulic steering actuator;
a pressure limiting system for limiting the pressure of hydraulic fluid supplied to the actuator, the pressure limiting system including at least one hydraulic line connected between the hydro-mechanical steering control unit and the tank and at least one pressure limitation valve connected in the at least one hydraulic line between the hydro-mechanical steering control unit and the tank, the pressure limiting system configured to limit the pressure of hydraulic fluid supplied to the steering actuator to a first pressure value (p1);
wherein the electronic control unit is configured to provide the second control output to control operation of the pressure limiting system so as to limit the pressure of hydraulic fluid provided to the steering actuator to a second pressure value (p2) which is lower than the first pressure value (p1) when the detected steering angle is greater than the first angle (α1).

4. A steering system as claimed in claim 3, wherein the at least one hydraulic line comprises a main hydraulic line connected between the hydro-mechanical steering control unit and the tank and a first pressure limitation valve in the main hydraulic line, the first pressure limitation valve configured to open above the first pressure (p1); the at least one hydraulic line including a bypass line connected in parallel to the first pressure limitation valve between the hydro-mechanical steering control unit and the tank , the bypass line comprising a series connection of a second pressure limitation valve configured to open above the second pressure (p2) and a blocking valve, the second pressure (p2) being lower than the first pressure (p1); wherein the electronic control unit is configured to provide the second control output to open the blocking valve when the detected steering angle is greater than the first angle (α1).

5. A steering system as claimed in claim 3, wherein the at least one pressure limitation valve is an electronically controllably proportional pressure limitation valve, the electronic control unit configured to provide the second control output to reduce the pressure at which the pressure limitation valve opens when the detected steering angle is greater than the first angle (α1) from pressures above the first pressure (p1) to pressures above the second pressure (p2).

6. The steering system claim 3, wherein the at least one hydraulic line is fluidly connected with a load sensing port (LS) of the hydro-mechanical steering control unit.

7. The steering system claim 3, wherein the at least one hydraulic line is fluidly connected with the inlet port (P) of the hydro-mechanical steering control unit.

8. The steering system of claim 4, wherein the second pressure of the second pressure limitation valve is adjustable, the electronic control unit configured to provide a third control output to the second pressure limitation valve to control the second pressure.

9. The steering system of claim 1, wherein the electronic control unit is configured to reduce the steering force according to a difference between the detected steering angle and the first angle when the detected steering angle is greater than the first angle (α1).

10. The steering system of claim 9, wherein the electronic control unit is configured to reduce the steering force in proportion to the difference between the detected steering angle and the first angle when the detected steering angle is greater than the first angle (α1).

11. The steering system claim 1, comprising first and second adjustable end stops configured to limit the steering angle of the first and second wheels to a maximum steering angle (αmax1; αmax2) that is greater than the first angle (α1; α2).

12. A hydraulic steering system for a vehicle comprising a hydraulic steering actuator connected to provide a steering force to at least one steered wheel of a vehicle; a steering actuator control system configured to receive a first control input and provide a first control output to the steering actuator; a steering angle sensor mounted to detect a steering angle of the at least one steered wheel and to provide a steering angle signal indicative of the detected steering angle; the steering actuator control system comprising an electronic control unit configured to receive the steering angle signal from the angle sensor and a hydro-mechanical steering control unit; the steering system further comprising a hydraulic pump configured to pump a supply of hydraulic fluid from a tank to the hydro-mechanical steering control unit and a pressure limiting system for limiting the pressure of hydraulic fluid supplied to the actuator from the pump, wherein the pump is a variable displacement pump and the pressure limiting system includes at least one hydraulic line connected between a load sensing port LS of the hydro-mechanical steering control unit and the tank and at least one pressure limitation valve connected in the at least one hydraulic line, the pressure limiting system configured to limit the pressure of hydraulic fluid supplied to the steering actuator to a first pressure value; wherein the electronic control unit is configured to monitor the steering angle signal and to provide a second control output to control operation of the pressure limiting system so as to limit the pressure of hydraulic fluid provided to the steering actuator to a second pressure value which is lower than the first pressure value if the steering angle signal is indicative that the detected steering angle is greater than a first angle.

13. A vehicle comprising a steering system claim 1.

14. The vehicle of claim 13, wherein the vehicle is an agricultural vehicle.

15. A method of operating a steering system comprising:
first and second steerably mounted wheels;
a hydraulic steering actuator connected to provide a steering force to the first and second wheels
a steering actuator control system configured to receive a first control input and provide a first control output to the steering actuator;
a steering angle sensor mounted to detect a steering angle of at least one of the first and second wheels and to provide a steering angle signal indicative of the detected steering angle;
the steering control system comprising an electronic control unit configured to receive the steering angle signal from the steering angle sensor and to provide a second control output operative to reduce the steering force by reducing the pressure of fluid provided to the hydraulic steering actuator;
the method comprising:
the electronic control unit monitoring the steering angle signal from the angle sensor and providing the second control output operative to reduce the steering force applied by the steering actuator to the first and second wheels by reducing the pressure of fluid provided to the hydraulic steering actuator if the steering angle signal is indicative that the detected steering angle is greater than a first angle (α1).

16. The method of claim 15, wherein the method comprises reducing the steering force according to a difference between the detected steering angle and the first angle when the detected steering angle is greater than the first angle (α1).

17. The method of claim 16, wherein the method comprises reducing the steering force in proportion to the difference between the detected steering angle and the first angle when the detected steering angle is greater than the first angle (α1).
